(19) United States
(12) Patent Application Publication
(10) Pub. No.: US 2005/0154803 A1
(43) Pub. Date: Jul. 14, 2005

(54) Memory accessing method

(75) Inventors: Chung-Ching Huang, Taipei (TW); Lin-Hung Chen, Taipei (TW); Hao-Lin Lin, Taipei (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Via Technologies, Inc.

(21) Appl. No.: 11/009,881

(22) Filed: Dec. 10, 2004

(30) Foreign Application Priority Data
Jan. 8, 2004 (TW) 093100478

(51) Int. Cl. G06F 13/28

(52) U.S. Cl. 710/33

(57) ABSTRACT

A method for accessing a memory of a computer system for BIOS codes optionally performs a detection procedure to realize a maximum memory burst read size of the memory according to a flag value upon the computer system is initialized. For example, the detection procedure is performed when the flag value is logic “1” and the detection procedure is not performed when the flag value is logic “0”. When the detection procedure is performed, read requests with sequentially reduced memory burst read sizes are asserted to the memory one by one until the maximum memory burst read size of the memory is realized. Then, the BIOS codes are read from the memory with the maximum memory burst read size.

### FIELD OF THE INVENTION

The present invention relates to a method for accessing a memory, and more particularly to a method for reading BIOS codes from a FWH flash ROM of a computer system.

### BACKGROUND OF THE INVENTION

In the architecture of the mainboard of a personal computer (PC), a flash ROM (read only memory) is customarily served as a storage device of BIOS (basic input/output system) codes and other important booting data required for booting the computer. Referring to FIG. 1, a flash ROM 10 storing therein BIOS codes and booting data is electrically connected to a LPC (low pin-count) bus host 12 (such as a south bridge chip) via a LPC bus 11. The LPC bus 11 is further connected to other peripheral equipment such as embedded controller 13 and super I/O controller 14 as shown. Giving the LPC specification R1.1 as an example, the flash ROM communicable therewith includes a LPC flash ROM, which is the most popular currently, and a FWH (firmware HUB) flash ROM, which is newly developed. Depending on the two flash ROM specifications, different considerations should be taken into while designing the system, which include, for example, data transmission frequency bandwidth and cost. Further, the memory burst read size of a FWH flash ROM, depending on choice, can be 1 byte, 2 bytes, 4 bytes, 16 bytes and even 128 bytes.

In current technique, for performing a POST (power-on self test) procedure, the BIOS codes need to be read from the flash memory, then decompressed and transferred to a DRAM (dynamic random access memory) of the computer. If a high data-reading rate can be supported by the flash ROM, the high booting rate can be assured of due to the high data transmission rate. Although a memory burst read size of a FWH flash ROM up to 128 bytes is available, the equivalent data-transmission rate cannot be guaranteed if the LPC bus host 12 is not pre-notified of the maximum memory burst read size of the FWH flash ROM. In fact, there has been no means for the LPC bus host 12 to realize in advance what memory burst read size of FWH flash ROM will be coupled to the assembled computer system. Therefore, in order not to suffer from any possible data reading errors, the conventional LPC bus host 12 reads data as if the maximum memory burst read size of the FWH flash ROM is one byte. Under this circumstance, it is apparent that the computer cannot make use of the advanced FWH flash ROM to enhance the efficiency of the entire system in this way.

### SUMMARY OF THE INVENTION

Therefore, the present invention provides a method for accessing a memory, which detects the maximum memory burst read size supported by the memory and reads BIOS codes from the memory with maximum memory burst read size.

The present invention relates to a method for accessing a memory of a computer system. The memory stores therein BIOS codes. The method comprises steps of: automatically performing a detection procedure to realize and record a desired memory burst read size of the memory upon the computer system is initialized under a first condition; and reading the BIOS codes from the memory with the desired memory burst read size.

In an embodiment, the first condition is that a flag is hoisted.

Preferably, the method further comprises a step of disabling the detection procedure under a second condition that the flag is not hoisted.

In an embodiment, the BIOS codes are read from the memory to a low pin-count bus host of the computer system via a low pin-count bus, and a value of the flag indicating whether the flag is hoisted or not is stored in a flag register of the low pin-count bus host.

In an embodiment, the desired memory burst read size is recorded in another register of the low pin-count bus host.

The low pin-count bus host, for example, is a south bridge chip.

In an embodiment, the detection procedure comprise steps of: a) asserting a read request with a first memory burst read size to the memory; b) asserting another read request with a second memory burst read size to the memory if the memory has not responded to the read request with the first memory burst read size for a predetermined period of time; c) repeating the step b) with changed memory burst read sizes until the memory responds to the latest read request; and d) recording a memory burst read size indicated by the latest read request as the desired memory burst read size.

Preferably, the second memory burst read size is smaller than the first memory burst read size, and in the step c), the changed memory burst read sizes are gradually reduced ones.

In an embodiment, the desired memory burst read size is a maximum memory burst read size.

The present invention further relates to a method for accessing a memory of a computer system, wherein the memory stores therein BIOS codes, and the method comprises steps of: optionally performing a detection procedure to realize a maximum memory burst read size of the memory according to a flag value upon the computer system is initialized; and reading the BIOS codes from the memory with the maximum memory burst read size after the detection procedure is performed.

In an embodiment, the detection procedure is performed when the flag value is logic “1” and the detection procedure is not performed when the flag value is logic “0”.

In an embodiment, the BIOS codes are read from the memory to a low pin-count bus host of the computer system via a low pin-count bus, and the flag value is stored in a flag register of the low pin-count bus host.

In an embodiment, the method further comprises a step of recording the maximum memory burst read size in a register of a low pin-count bus host that is to read the BIOS codes from the memory after the detection procedure is performed.

### BRIEF DESCRIPTION OF THE DRAWINGS

The present invention may best be understood through the following description with reference to the accompanying drawings, in which:

FIG. 1 is a block diagram schematically showing a conventional LPC bus system;

FIG. 2 is a block diagram schematically showing a LPC bus system where BIOS codes are read from a FWH flash ROM to a LPC bus host according to an embodiment of the present invention;

FIGS. 3A and 3B illustrate a flowchart of a method for reading BIOS codes from a FWH flash ROM according to an embodiment of the present invention; and

FIG. 4 is a schematic diagram showing various recorded bits representing different maximum memory burst read sizes supported by the FWH flash ROM, respectively.

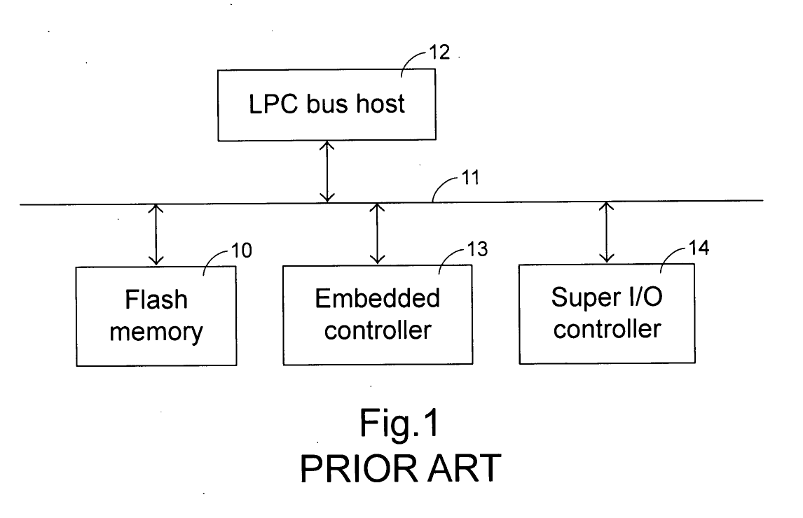

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

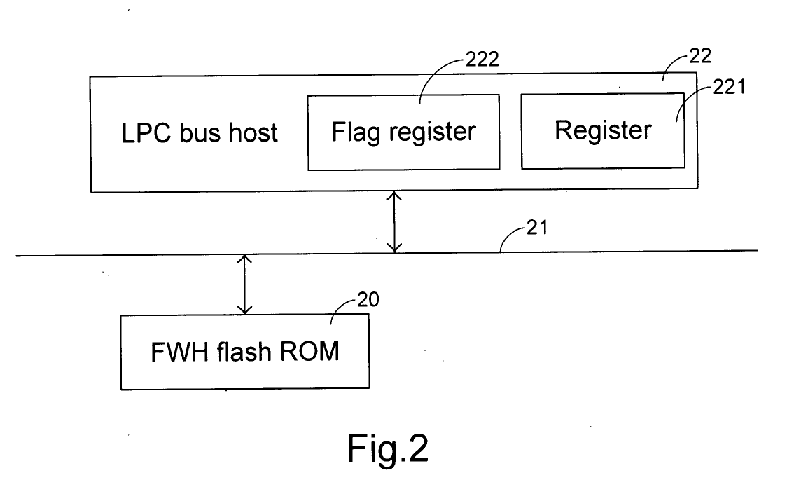

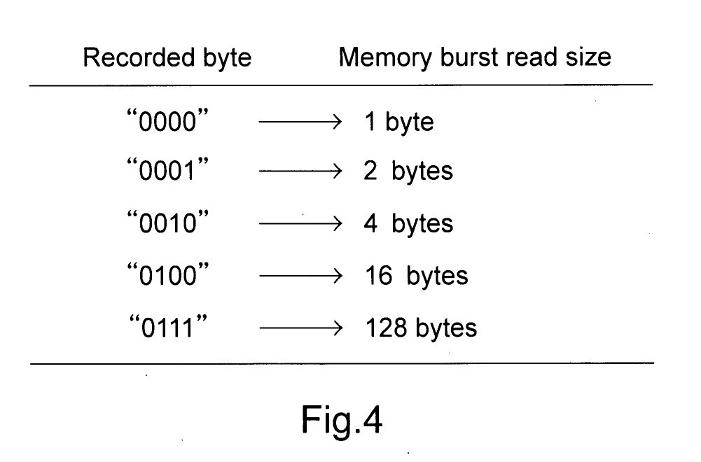

Hereinafter, a method for reading booting codes from a FWH flash ROM to a LPC bus host according to an embodiment of the present invention will be illustrated with reference to the LPC bus system of FIG. 2. First, a read request of a certain memory burst read size is issued by the LPC bus host 22 to the FWH flash ROM 20 via the LPC bus 21. After the LPC bus host 22 issues the read request, the LPC bus host 22 waits a predetermined period of time to see if there is any response from the FWH flash ROM 20. The waiting period is preset depending on practical requirements. If the FWH flash ROM 20 responds to the read request in time, that memory burst read size would be determined as the desired memory burst read size and recorded into a register 221 of the LPC bus host 22. Then, the LPC bus host 22 is read BIOS codes and compressed booting data from the FWH flash ROM 20 with the desired memory burst read size for performing the booting and self-test procedure. Otherwise, the LPC bus host 22 will issue another read request and waits for the response of the LPC bus host 22 issues the read request as mentioned above. The issuing and waiting procedures are repeated until the desired memory burst read size is determined. Then, the last memory burst read size is recorded in the register 221 and used to access the memory. Examples of the recordation of memory burst read sizes are shown in the table of FIG. 4. They can be recorded as one-byte data. For example, the byte “0000” stored in the register represents the 1-byte memory burst read size; the byte “0001” stored in the register represents the 2-byte memory burst read size; the byte “0010” stored in the register represents the 4-byte memory burst read size; the byte “0100” stored in the register represents the 16-byte memory burst read size; and the byte “0111” stored in the register represents the 128-byte memory burst read size.

Generally, it is preferred to read BIOS codes from the FWH flash ROM 20 with the maximum memory burst read size supported by the memory in order to maximize the data transmission efficiency of the FWH flash ROM 20 and enhance the booting performance. In order to realize the maximum memory burst read size, the above repetitive issuing and waiting procedures for maximum memory burst read size detection are performed from the designated largest memory burst read size to the designated smallest memory burst read size. For example, under current architecture, the memory burst read sizes are gradually reduced from 128 bytes, then 16 bytes, 4 bytes, 2 bytes and finally 1 byte. Preferably, the smallest memory burst read size, i.e. 1 byte, is pre-recorded in the register 221. Once the FWH flash ROM 20 does not respond to the read request of the 2-byte memory burst read size, it is automatically determined that the only memory burst read size supported by the FWH flash ROM 20 is one byte.

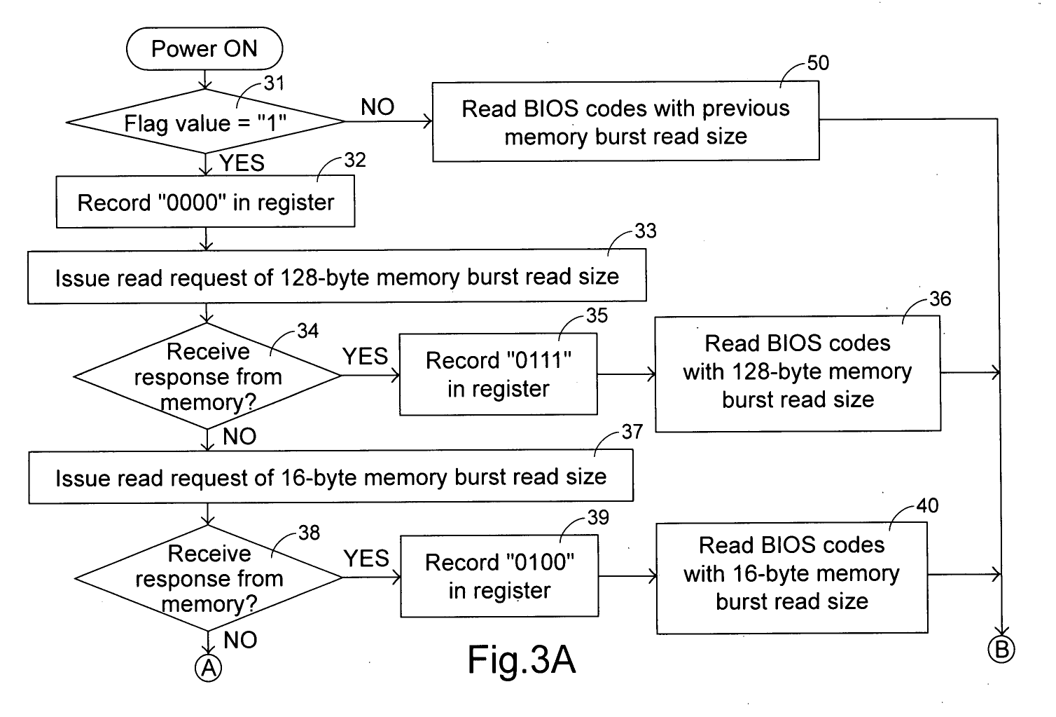

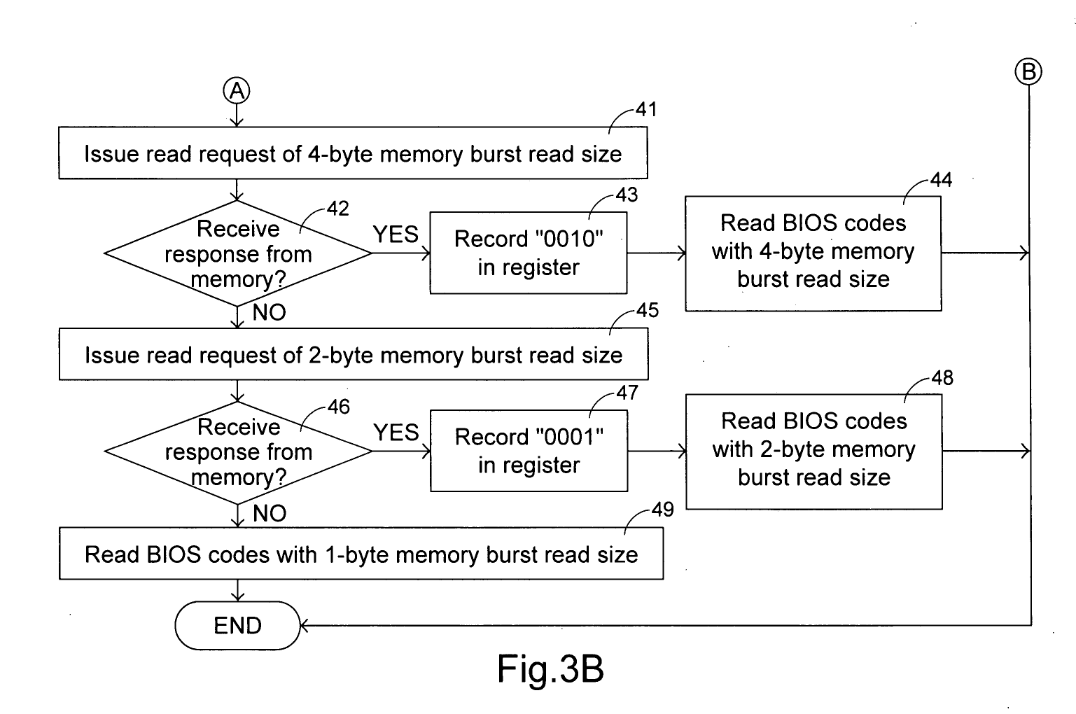

Further, in the case that re-detecting the maximum memory burst read size of the FWH flash ROM is not necessary, e.g. no FWH flash ROM is changed, the maximum memory burst read size detection can be disabled to exempt from the detection time and thus speed up the booting procedure. In an embodiment with reference to FIG. 2, a certain flag value is stored in a flag register 222 of the LPC bus host 22. If the flag value is set to be “1” by the user, the maximum memory burst read size detection is enabled. On the contrary, if the flag value is set to be “0” by the user, the maximum memory burst read size detection is disabled. Then, the reading operation of the BIOS codes and associated data will be performed with the memory burst read size previously recorded in the register 221. A preferred embodiment of the present invention will be illustrated with reference to the flowchart of FIGS. 3A and 3B.

First of all, whether the maximum memory burst read size detection is to be performed or not is determined (Step 31) by referring to the flag value stored in the flag register of the LPC bus host. If the flag value is “0” other than “1”, no maximum memory burst read size detection is to be performed, and the LPC bus host reads BIOS codes and associated data from the FWH flash ROM with previously recorded memory burst read size (step 50). Otherwise, the maximum memory burst read size detection is initialized. In the beginning, the byte “0000” representing a 1-byte memory burst read size is pre-recorded in the register of the LPC bus host (Step 32). A read request of a 128-byte memory burst read size is first issued (Step 33) and the response from the FWH flash ROM is detected (Step 34). If the FWH flash ROM responds to the read request within a predetermined period of time, the byte “0111” will be recorded in the register of the LPC host, substituting for the pre-recorded “0000”, to represent that the maximum memory burst read size supported by the FWH flash ROM is 128 bytes (Step 35). Accordingly, the LPC bus host can read BIOS codes and associated data from the FWH flash ROM with the 128-byte memory burst read size (step 36).

On the other hand, if the FWH flash ROM does not respond to the read request before the predetermined period of time is due, the LPC bus host will issue another read request of a 16-byte memory burst read size (Step 37) and the response from the FWH flash ROM is detected (Step 38). If the FWH flash ROM responds to the read request within a predetermined period of time, the byte “0100” will be recorded in the register of the LPC host, substituting for the pre-recorded “0000”, to represent that the maximum memory burst read size supported by the FWH flash ROM is 16 bytes (Step 39). Accordingly, the LPC bus host can read BIOS codes and associated data from the FWH flash ROM with the 16-byte memory burst read size (Step 40).

Further, if the FWH flash ROM does not respond to the read request of the 16-byte memory burst read size before the predetermined period of time is due, the LPC bus host will issue another read request of a 4-byte memory burst read size (Step 41) and the response from the FWH flash ROM is detected (Step 42). If the FWH flash ROM responds to the read request within a predetermined period of time, the byte “0010” will be recorded in the register of the LPC host, substituting for the pre-recorded “0000”, to represent that the maximum memory burst read size supported by the FWH flash ROM is 4 bytes (Step 43). Accordingly, the LPC bus host can read BIOS codes and associated data from the FWH flash ROM with the 4-byte memory burst read size (Step 44).

Likewise, if the FWH flash ROM does not respond to the read request of the 4-byte memory burst read size before the predetermined period of time is due, the LPC bus host will issue another read request of a 2-byte memory burst read size (Step 45) and the response from the FWH flash ROM is detected (Step 46). If the FWH flash ROM responds to the read request within a predetermined period of time, the byte “0001” will be recorded in the register of the LPC host, substituting for the pre-recorded “0000”, to represent that the maximum memory burst read size supported by the FWH flash ROM is 2 bytes (Step 47). Accordingly, the LPC bus host can read BIOS codes and associated data from the FWH flash ROM with the 2-byte memory burst read size (Step 48). On the contrary, if the FWH flash ROM does not respond to the read request of the 2-byte memory burst read size before the predetermined period of time is due, the BIOS-codes reading operation will be performed with the 1-byte memory burst read size (Step 49).

According to the present invention, maximum memory burst read size detection is optionally performed in advance so that the LPC bus host can read the BIOS codes and associated booting data from the FWH flash ROM with the maximum memory burst read size supported by the FWH flash ROM. Therefore, the data-transmission efficiency and booting performance can be enhanced. The LPC bus host, for example, can be the south bridge chip of the computer system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A method for accessing a memory of a computer system, said memory storing therein BIOS codes, said method comprising steps of:
automatically performing a detection procedure to realize and record a desired memory burst read size of said memory upon said computer system is initialized under a first condition; and
reading said BIOS codes from said memory with said desired memory burst read size.

2. The method according to claim 1 wherein said first condition is that a flag is hoisted.

3. The method according to claim 2 further comprising a step of disabling said detection procedure under a second condition that said flag is not hoisted.

4. The method according to claim 2 wherein said BIOS codes are read from said memory to a low pin-count bus host of said computer system via a low pin-count bus, and a value of said flag indicating whether said flag is hoisted or not is stored in a flag register of said low pin-count bus host.

5. The method according to claim 4 wherein said desired memory burst read size is recorded in another register of said low pin-count bus host.

6. The method according to claim 4 wherein said low pin-count bus host is a south bridge chip.

7. The method according to claim 1 wherein said detection procedure comprise steps of:
a) asserting a read request with a first memory burst read size to said memory;
b) asserting another read request with a second memory burst read size to said memory if said memory has not responded to said read request with said first memory burst read size for a predetermined period of time;
c) repeating said step b) with changed memory burst read sizes until said memory responds to the latest read request; and
d) recording a memory burst read size indicated by the latest read request as said desired memory burst read size.

8. The method according to claim 7 wherein said second memory burst read size is smaller than said first memory burst read size.

9. The method according to claim 7 wherein in said step c), said changed memory burst read sizes are gradually reduced ones.

10. The method according to claim 9 wherein said desired memory burst read size is a maximum memory burst read size.

11. A method for accessing a memory of a computer system, said memory storing therein BIOS codes, said method comprising steps of:
optionally performing a detection procedure to realize a maximum memory burst read size of said memory according to a flag value upon said computer system is initialized; and
reading said BIOS codes from said memory with said maximum memory burst read size after said detection procedure is performed.

12. The method according to claim 10 wherein said detection procedure is performed when said flag value is logic “1” and said detection procedure is not performed when said flag value is logic “0”.

13. The method according to claim 10 wherein said BIOS codes are read from said memory to a low pin-count bus host of said computer system via a low pin-count bus, and said flag value is stored in a flag register of said low pin-count bus host.

14. The method according to claim 10 further comprising a step of recording said maximum memory burst read size in a register of a low pin-count bus host that is to read said BIOS codes from said memory after said detection procedure is performed.

15. The method according to claim 13 wherein said low pin-count bus host is a south bridge chip.

16. The method according to claim 10 wherein said detection procedure comprise steps of:
a) asserting a read request with a first memory burst read size to said memory;
b) asserting another read request with a second memory burst read size to said memory if said memory has not responded to said read request with said first memory burst read size for a predetermined period of time;
c) repeating said step b) with changed memory burst read sizes until said memory responds to the latest read request; and
d) recording a memory burst read size indicated by the latest read request as said maximum memory burst read size.

17. The method according to claim 15 wherein said second memory burst read size is smaller than said first memory burst read size.

18. The method according to claim 15 wherein in said step c), said changed memory burst read sizes are gradually reduced ones.
